(19) United States
(12) Patent Application Publication
(10) Pub. No.: US 2012/0306431 A1
(43) Pub. Date: Dec. 6, 2012

(54) PROTECTIVE COVER WITH BATTERY FOR ELECTRONIC DEVICE

(75) Inventors: TANG LI, Shenzhen City (CN); JIAN LI, Shenzhen City (CN); LIAN-CHENG HUANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/193,846

(22) Filed: Jul. 29, 2011

(30) Foreign Application Priority Data
Jun. 3, 2011 (CN) 201110148525.6

(51) Int. Cl. H01M 10/46

(52) U.S. Cl. 320/101

(57) ABSTRACT

A protective cover for an electronic device includes a housing, a rechargeable battery received in the housing, a printed circuit board also received in the housing. The printed circuit board includes a charging-discharging module electrically connected to the battery. The protective cover also includes a solar panel used for collecting light-energy, and an opto-electronic conversion module formed on the solar panel and electrically connected to the battery.

### BACKGROUND

1. Technical Field

The present disclosure relates to protective covers, particularly to a protective cover with a battery for an electronic device.

2. Description of Related Art

Portable electronic devices such as mobile phones typically have rechargeable batteries. When the battery runs down, a user must either wait while recharging the battery, which is inconvenient, or use a backup battery, which adds to the cost of using the device.

Therefore, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the protective cover. Moreover, in the drawings like reference numerals designate corresponding parts throughout the several views. Wherever possible, the same reference numerals are used throughout the drawings to refer to the same or like elements of an embodiment.

FIG. 1 is an isometric view of part of a protective cover.

FIG. 2 is an exploded, isometric view of the protective cover of FIG. 1.

FIG. 3 is similar to FIG. 2, but viewed from another angle.

### DETAILED DESCRIPTION

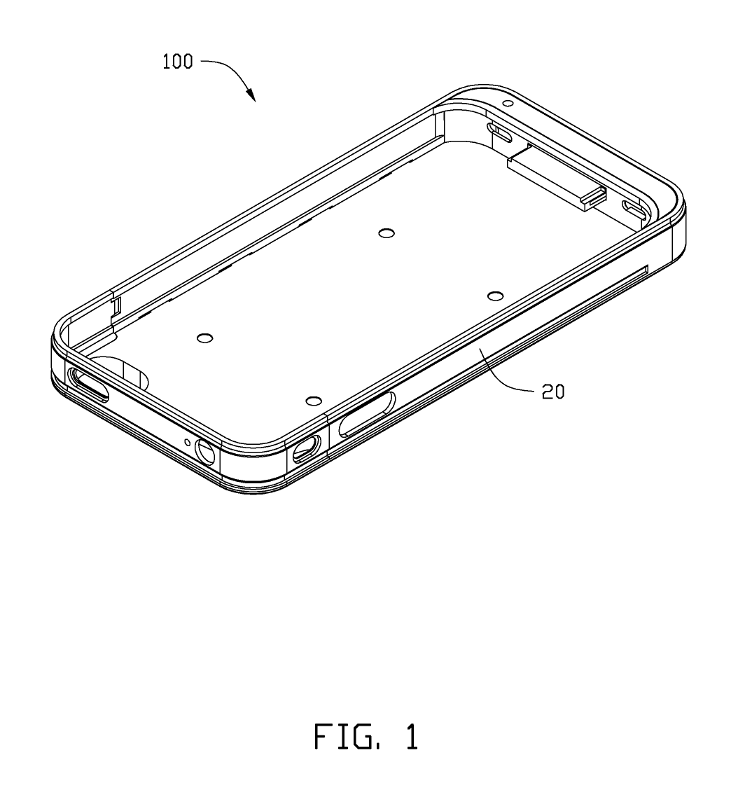

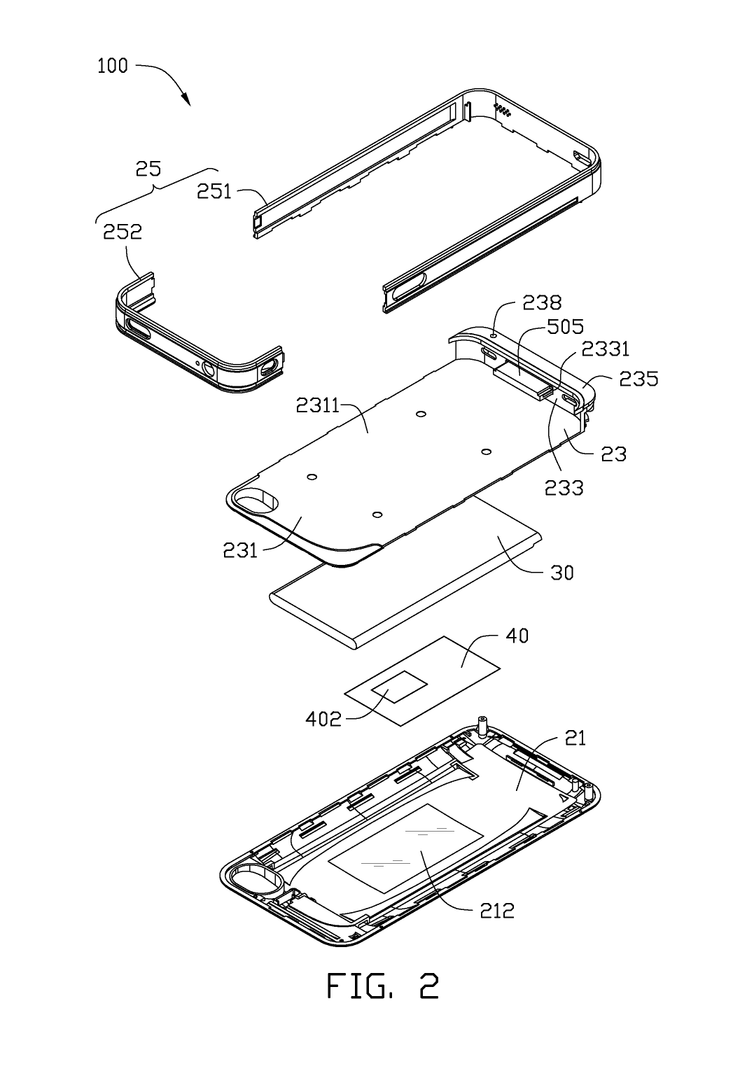

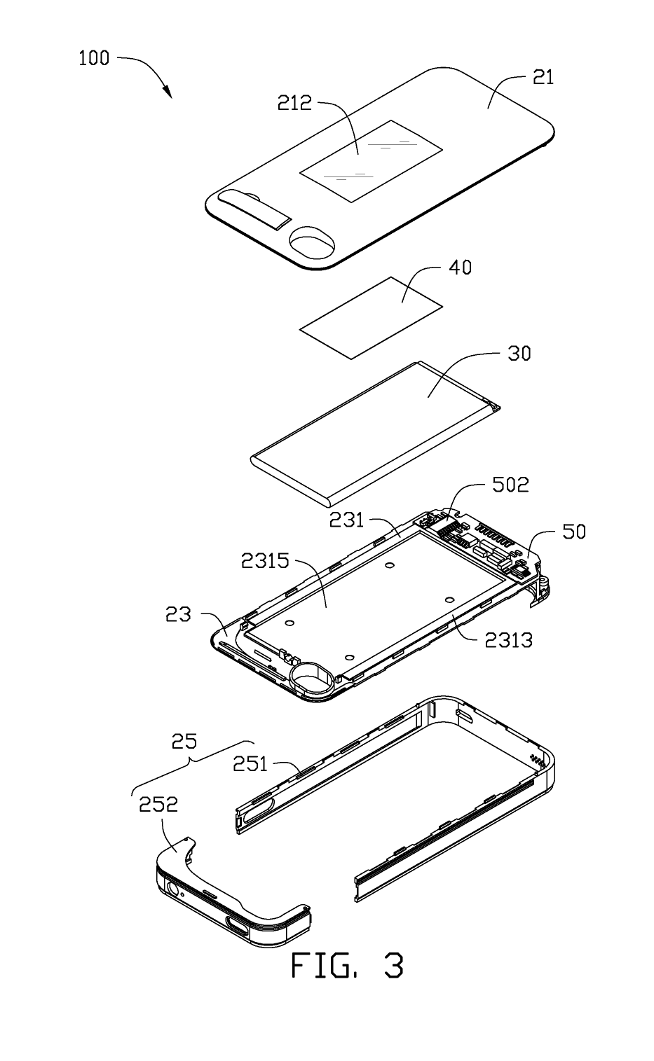

Referring to FIGS. 1 to 3, an embodiment of a protective cover 100 includes a housing 20, a battery 30, a solar panel 40, and a printed circuit board 50. The battery 30, the printed circuit board 50 and the solar panel 40 are all received in the housing 20. The protective cover 100 can be used to protect an electronic device such as a mobile phone, MP3 player, or personal digital assistant from damages, and can also charge the electronic device as needed. In the illustrated embodiment, the protective cover 100 is applied to a mobile phone.

The housing 20 includes a bottom cover 21, a fixing member 23, and a side cover 25. The bottom cover 21 is fixed to the fixing member 23, such that the bottom cover 21 and the fixing member 23 cooperatively define a receiving space for the battery 30, the solar panel 40, and the printed circuit board 50. The battery 30 is fixed near the middle portion of the fixing member 23, the solar panel 40 is adhered to the outer surface of the battery 30 toward the bottom cover 21, and the printed circuit board 50 is fixed at one end of the fixing member 23 adjacent the battery 30. The side cover 25 is sleeved on the fixing member 23 at a side of the fixing member 23 away from the bottom cover 21. The side cover 25 and the fixing member 23 cooperatively define a receiving space for a mobile phone (not shown).

The bottom cover 21 is made of hard plastic. In an alternative embodiment, the bottom cover 21 can be made of soft plastic to enhance the elasticity, handleability, and the skid resistance of the bottom cover 21. The bottom cover 21 has a shape corresponding to the underside of the mobile phone. The bottom cover 21 includes a transparent plate 212 formed at the middle portion of the bottom cover 21. The transparent plate 212 is made of transparent material. In order to ensure light can thoroughly irradiate the solar panel 40, size of the transparent plate 212 is bigger than that of the solar panel 40. In an alternative embodiment, the transparent plate 212 can be omitted to enhance irradiation of the solar panel 40.

The fixing member 23 can be a substantially L-shaped board. The fixing member 23 is made of a strong and hard plastic to support the housing 20. The fixing member 23 includes a base board 231, a sidewall 233 extending across from an end of the base board 231 adjacent to the printed circuit board 50, and a covering board 235 fixed on top of the sidewall 233 to cover the sidewall 233. The base board 231 is substantially flat. The four corners of the base board 231 can be shaped to correspond to the shape of the bottom cover 21. The base board 231 includes an upper surface 2311 and a lower surface 2313. The sidewall 233 extends across from an end of the upper surface 2311. The sidewall 233 includes an inserting hole 2331 in the middle of the sidewall 233. The lower surface 2313 includes a bed region (receiving groove 2315) to receive the battery 30. The covering board 235 is shaped to correspond to the shape of the end of the base board 231. A charging switch 238 electrically connected to the printed circuit board 50 is formed on the covering board 235. The charging switch 238 is capable of changing the charging mode of the mobile phone. When the charging switch 238 is turned on, the mobile phone can be powered and charged by the battery 30, and when the charging switch 238 is turned off, the mobile phone receives power from its own battery.

The side cover 25 can be a substantially rectangular frame. The side cover 25 includes a fixing portion 251 and an assembling portion 252. The fixing portion 251 is sleeved at an end of the fixing member 23 adjacent to the sidewall 233. The assembling portion 252 is detachably attached to the fixing portion 251. In the illustrated embodiment, the side cover 25 is made of a relatively soft plastic material to achieve elasticity, and to avoid scratching the cover of the mobile phone.

The battery 30 can be a rechargeable battery. The battery 30 can be a specialized type of battery corresponding to a specialized type of mobile phone, or the battery 30 can be of commonplace type of battery.

The solar panel 40 can be a film of amorphous silicon or mono-crystalline silicon. In the illustrated embodiment, the solar panel 40 adheres to the surface of the battery 30 towards the transparent plate 212 of the bottom cover 21. The solar panel 40 includes an opto-electronic conversion module 402 electrically connected to the battery 30 respectively. The solar panel 40 can use light energy from the sun or other light sources to generate electricity and recharge the battery 30.

The printed circuit board 50 is fixed on an end of the lower surface 2313 adjacent to the sidewall 233. The printed circuit board 50 includes a charging-discharging module 502 and a charging plug 505. An end of the charging plug 505 is electrically connected to the charging-discharging module 502, and the other end of the charging plug 505 extends through the inserting hole 2331 toward an end of the fixing member 231 away from the sidewall 233. In the illustrated embodiment, the charging interface of the mobile phone is a USB or mini USB type, and the charging plug 505 is a USB plug corresponding to the charging interface. When the mobile phone is received in the housing 100, the end of the mobile phone with the charging interface resists the sidewall 233, and the charging plug 505 is inserted in the charging interface. In an alternative embodiment, the charging interface and the charging plug 505 can be other types of connectors.

In assembling the housing 100, the battery 30 is received in the receiving groove 2315 of the fixing member 23 and is automatically connected to the charging-discharging module 502. Then, the solar panel 40 is attached to the surface of the battery 30, and electrically connected to it. The bottom cover 21 is fixed on the fixing member 23 with the solar panel 40 facing toward the transparent plate 212. As a final step, the side cover 25 is sleeved on the fixing member 23.

To assemble the mobile phone in the housing 100, the assembling portion 252 is disassembled, the end of the mobile phone with the charging interface is inserted into the housing 100 through an opening of the fixing portion 251. The bottom cover of the mobile phone resists the upper surface 2311 of the fixing member 23, with the charging plug 505 inserted in the charging interface of the mobile phone. The assembling portion 252 is finally assembled to the fixing portion 251, and the mobile phone is thus received in the housing 100. When the charging switch 238 is turned on, the battery 30 can charge the mobile phone, when the charging switch 238 is turned off, the mobile phone is powered by its own battery.

The solar panel 40 and the battery 30 are both received in the housing 100. The solar panel 40 can charge the battery 30 continuously as it receives light. Using of the housing 100 is thereby convenient and environmentally friendly. The size of the solar panel 40 is small and it is low in weight, this reduces both the size and the weight of the housing 100. If the mobile phone's own battery and the battery 30 are both drained to depletion, the solar panel 40 can also provide enough electrical energy for urgent communication.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A protective cover for an electronic device, comprising:
a housing;
a battery received in the housing;
a printed circuit board received in the housing, the printed circuit board comprising a charging-discharging module electrically connected to the battery;
a solar panel for charging the battery; and
an opto-electronic conversion module formed on the solar panel and electrically connected to the battery.

2. The protective cover for the electronic device of claim 1, wherein the solar panel is a film of amorphous silicon adhering to the surface of the battery.

3. The protective cover for the electronic device of claim 1, wherein the solar panel is a film of mono-crystalline silicon adhering to the surface of the battery.

4. The protective cover for the electronic device of claim 1, wherein the housing comprise a bottom cover, a fixing member, and a side cover; the bottom cover is fixed to the fixing member, such that the bottom cover and the fixing member cooperatively define a receiving space to receive the battery, the solar panel, and the printed circuit board; the side cover is sleeved on the fixing member at a side of the fixing member away from the bottom cover.

5. The protective cover for the electronic device of claim 4, wherein the side cover is made of a soft plastic material to achieve elasticity, and to avoid scratching the cover of the electronic device.

6. The protective cover for the electronic device of claim 4, wherein the bottom cover comprises a transparent plate corresponding to the solar panel.

7. The protective cover for the electronic device of claim 6, wherein the transparent plate is made of transparent material.

8. The protective cover for the electronic device of claim 7, wherein the transparent plate is omitted to enhance irradiation of the solar panel.

9. The protective cover for electronic device of claim 4, wherein the fixing member comprises a base board, a sidewall extending across from an end of the base board, and a covering board fixed on a top of the sidewall to cover the sidewall.

10. The protective cover for the electronic device of claim 4, wherein the base board comprises an upper surface and a lower surface, the sidewall extends across from an end of the upper surface.

11. The protective cover for the electronic device of claim 9, wherein the sidewall comprises an inserting hole at the middle portion of the sidewall.

12. The protective cover for the electronic device of claim 10, wherein the lower surface comprises a receiving groove to receive the battery.

13. The protective cover for electronic device of claim 4, wherein the covering board comprises a charging switch electrically connected to the printed circuit board.

14. The protective cover for electronic device of claim 4, wherein the side cover comprises a fixing portion and an assembling portion detachably attached to the fixing portion.

15. The protective cover for electronic device of claim 1, wherein the battery is a rechargeable battery, and the battery is a specialized type of battery corresponding to a specialized type of mobile phone.

16. The protective cover for the electronic device of claim 1, wherein the battery is a conventional rechargeable battery.

17. The protective cover for the electronic device of claim 1, wherein the printed circuit board comprises a charging-discharging module and a charging plug electrically connected to the charging-discharging module.

18. The protective cover for the electronic device of claim 12, wherein the printed circuit board is fixed on an end of the lower surface adjacent to the sidewall.
